(19) United States
(12) Patent Application Publication
(10) Pub. No.: US 2003/0033210 A1
(43) Pub. Date: Feb. 13, 2003

(54) Delivery notification system

(76) Inventors: Wen Zhen Ma, ShenZhen (CN); Qiong Shuai Chen, ShenZhen (CN); Zhe Xiong Liu, ShenZhen (CN); Rui Yue, ShenZhen (CN)

Correspondence Address: Wei Te (Joseph) Chung, Foxconn International, Inc., 1650 Memorex Drive, Santa Clara, CA, 95050, US

(21) Appl. No.: 09/962,070

(22) Filed: Sep. 24, 2001

(30) Foreign Application Priority Data
Aug. 8, 2001 (TW) 90119283

(51) Int. Cl. G06F 17/60

(52) U.S. Cl. 705/26

(57) ABSTRACT

A delivery notification (D/N) system based on an electronic communications network is provided for performing delivery notification tasks in real time. Each user of the D/N system is assigned with a username and a password that cooperate to uniquely identify the user and determine a specific authority for the user to access the D/N system. The D/N system comprises a base information module including all base information needed by the D/N system, a demand module which allows a purchaser to key in and store purchase order information on the network and to browse delivery information provided by suppliers, a supplier module which allows suppliers to browse and confirm the purchase order information in real time and to create delivery information and store the delivery information in the D/N system, and a reporting module which allows users to search information and to print out searched information in tabular format.

### FIELD OF THE INVENTION

This invention is related to electronic delivery notification systems, and especially to such systems that allow transmission and exchange of information over electronic communications networks in order to achieve delivery notification in real time.

### BACKGROUND OF THE INVENTION

It is essential for manufacturers to minimize manufacturing costs by properly controlling inventory. Normally, overstocking does not occur if a manufacturer sells its products as scheduled. However, a manufacturer may be forced to delay dispatch of sold products due to unforeseen reasons affecting a buyer or a forwarder. Another reason for overstocking is excess purchasing. This can be effectively improved by implementing material requirement planning (MR). However, typical purchasing procedures are very complex, and there are many uncertainties inherent in the whole purchasing process. In particular, unexpected delays occur between issuance of a purchase order and receipt of goods. Furthermore, materials finally delivered to a manufacturer frequently do not fully match the specific items and quantities listed in the purchase order. All these kinds of circumstances make controlling of the purchasing process very difficult.

A public prior art H1,734 published by the United States Patent and Trademark Office (USPTO) discloses a means of inventory management. This prior art provides a method for tracking usage of supplies and predicting purchasing requests based on historical data related to rate of usage of supplies. Purchasing request predictions include what will be purchased, and the date of anticipated delivery. However, this prior art focuses on a purchaser who manages inventory within the bounds of its own organization only. Unexpected contingencies revolving around suppliers are not addressed.

U.S. Pat. No. 6,134,557 discloses a materials and supplies ordering system for the construction field. First, a purchaser collects information on suppliers such as pricing and terms of credit, and then selects a supplier to place an order with. The purchaser determines what to purchase according to its own construction project, and transfers related purchase orders to the supplier for processing. The supplier responds by sending the purchaser information on available materials, estimated prices, and delivery dates. Finally, the purchaser confirms the order. This system is adapted for circumstances where a supplier has not yet been determined by a purchaser, and where a trading relationship between a purchaser and a supplier is not ongoing. In such circumstances, delivery information such as delivery date and list of supplies is mostly determined by the supplier. The purchaser plays a relatively passive role.

### SUMMARY OF THE INVENTION

A primary object of the present invention is to provide a delivery notification system which allows users to transmit and exchange information over an electronic communications network.

Another object of the present invention is to provide a delivery notification system which allows suppliers to view purchase order information created by a purchaser, and to create delivery information in response to the purchase order information on an electronic communications network.

A further object of the present invention is to provide a delivery notification system which allows suppliers to notify a purchaser in real time when such suppliers cannot satisfy requirements contained in purchase order information.

A still further object of the present invention is to provide a delivery information system which provides a purchaser with real-time information of an entire delivery system in order that the purchaser has enough time to deal with a situation where suppliers cannot satisfy requirements contained in purchase order information.

A delivery notification system of the present invention allows all users to transmit and exchange information over an electronic communications network. The delivery notification system allows delivery notification tasks to be performed in real time. Each user of the delivery notification system is assigned with a username and a password. The username and password cooperate to uniquely identify the user, and to determine a specific authority for the user to access the delivery notification system.

The delivery notification system comprises a base information module, a demand module, a supplier module and a reporting module. The base information module allows users to create and maintain all base information needed by the delivery notification system. System administrators create and maintain the delivery notification system based on the base information provided by the users in advance. The demand module allows a purchaser to browse supplier information, key in and store purchase order information on the network, and browse what suppliers feed back. The purchaser creates purchase order information based on bills of material and current inventory, and stores the purchase order information in the delivery notification system. The supplier module allows suppliers to browse and confirm purchase order information in real time, and to create delivery information. Suppliers create the delivery information based on the purchase order information, and store the delivery information in the delivery notification system. The reporting module allows users to search information including purchase order information and delivery information, and to print out searched information in tabular format.

These and other objects and features of the present invention will become more fully apparent from the following description and appended claims, and may be learned by practice of the invention as set forth hereinafter.

### BRIEF DESCRIPTION OF THE DRAWINGS

FIG. 1 is a block diagram of an operational environment in which a delivery notification (D/N) system in accordance with a preferred embodiment of the present invention operates;

FIG. 2 is a base information table showing basic information needed by the D/N system in accordance with the preferred embodiment of the present invention;

FIG. 3 is a purchase note of the D/N system in accordance with the preferred embodiment;

FIG. 4 is a bill of lading of the D/N system in accordance with the preferred embodiment;

FIG. 5 is a delivery advice of the D/N system in accordance with the preferred embodiment;

FIG. 6 is a confirmed bill of lading of the D/N system-in accordance with the preferred embodiment;

FIG. 7 is a block diagram showing information flow among a user, an electronic communications network, a database, and the D/N system in accordance with the preferred embodiment;

FIG. 8 shows a hierarchical structure of modules of the D/N system in accordance with the preferred embodiment;

FIG. 9 is a data flow chart showing various information transmitted among various parts of the D/N system in accordance with the preferred embodiment;

FIG. 10 is a flow chart of tasks performed by a purchaser in the D/N system in accordance with the preferred embodiment; and

FIG. 11 is a flow chart of tasks performed by a supplier in the D/N system in accordance with the preferred embodiment.

### DETAILED DESCRIPTION OF THE PREFERRED EMBODIMENT

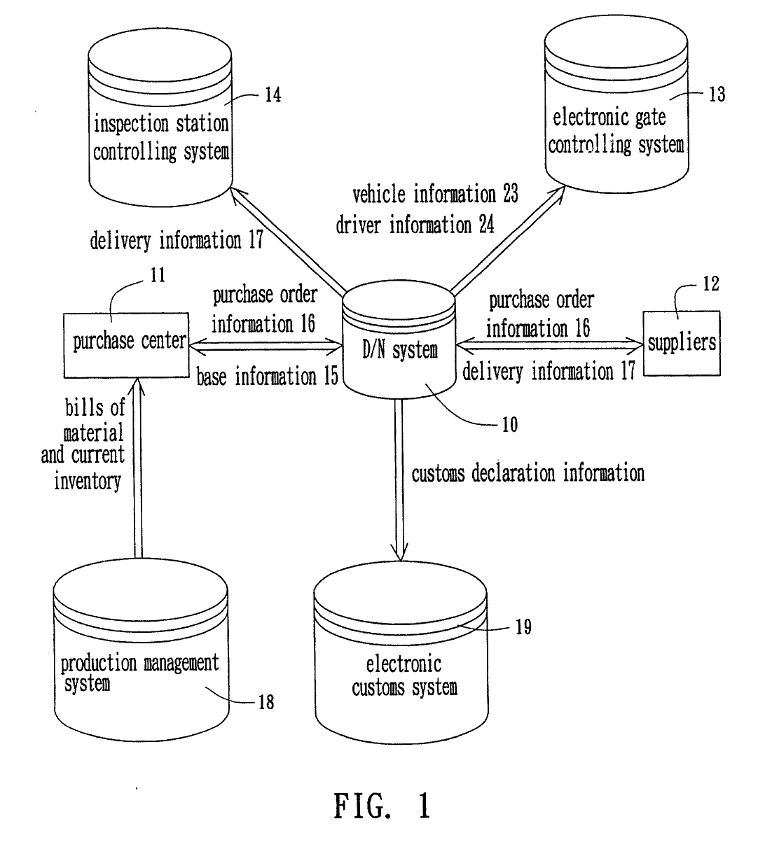

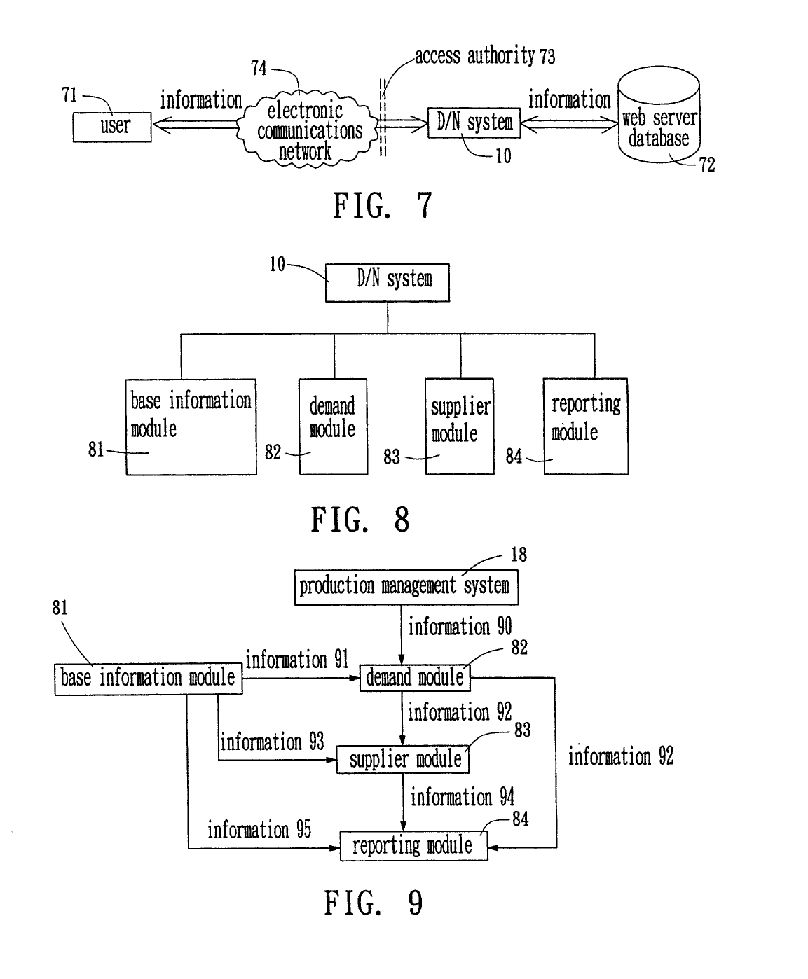

FIG. 1 is a block diagram of an operational environment in which a delivery notification (D/N) system 10 of a preferred embodiment of the present invention operates. The D/N system 10 serves as a bridge for receiving, storing and maintaining information among a purchase center 11, a plurality of suppliers 12, an electronic gate controlling system 13, an inspection station controlling system 14 and an electronic customs system 19. The D/N system 10 is an application based on an electronic communications network 74 (see FIG. 7). In the preferred embodiment, the network 74 is the Internet. In alternative embodiments, the network 74 may further or alternatively comprise one or more intranets. All information can be processed in real time. The purchase center 11 is typically a purchasing department of a purchaser that deals with all purchasing affairs of the purchaser. System administrators first key in and store base information 15 in the D/N system 10. Then the purchaser creates purchase order information 16 based on a bill of material (BOM) of each demanded product and on current inventory information provided by a production management system 18. The purchaser stores the created purchase order information 16 in the D/N system 10. One or more suppliers 12 access the D/N system 10 to obtain the purchase order information 16, arrange schedules of manufacturing and delivery according to the purchase order information 16, create delivery information 17, and store the delivery information 17 in the D/N system 10.

The D/N system 10 provides delivery vehicle information 23 and driver information 24 to the electronic gate controlling system 13. When a delivery vehicle carrying goods arrives at an electronic gate (not shown) at a delivery destination, inspectors use the electronic gate controlling system 13 to check whether the delivery vehicle and the driver match the vehicle and driver information 23, 24 stored in the D/N system 10. If the vehicle and driver match the stored information, the vehicle is permitted to pass through the electronic gate. If either or both the vehicle and driver do not match the stored information, the vehicle is not permitted to pass through.

Once a delivery vehicle has passed through the electronic gate, inspectors use the inspection station controlling system 14 to check whether the delivered goods match the delivery information 17 stored in the D/N system 10. If the goods match the stored information, the goods are accepted. If the goods do not match the stored information, the goods are refused.

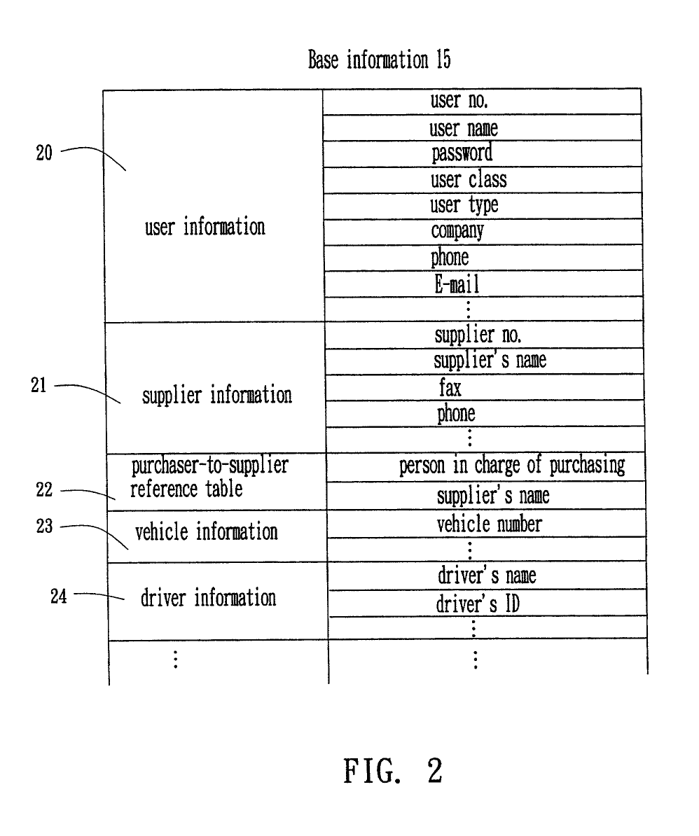

Referring to FIG. 2, the base information 15 comprises all basic information needed by the D/N system 10. This includes user information 20, supplier information 21, a purchaser-to-supplier reference table 22, vehicle information 23, and driver information 24. User information 20 includes various groups of user names and passwords, each group having a pre-determined user access authority. The user information 20 is mainly for system administrators of the D/N system 10 to manage login information of each user. The purchaser-to-supplier reference table 22 provides selectable supplier information to each person in charge of purchasing. The vehicle information 23 and driver information 24 include selectable vehicles and drivers that the suppliers can choose to have goods delivered. The supplier information 21 and the purchaser-to-supplier reference table 22 help a purchaser create the purchase order information 16.

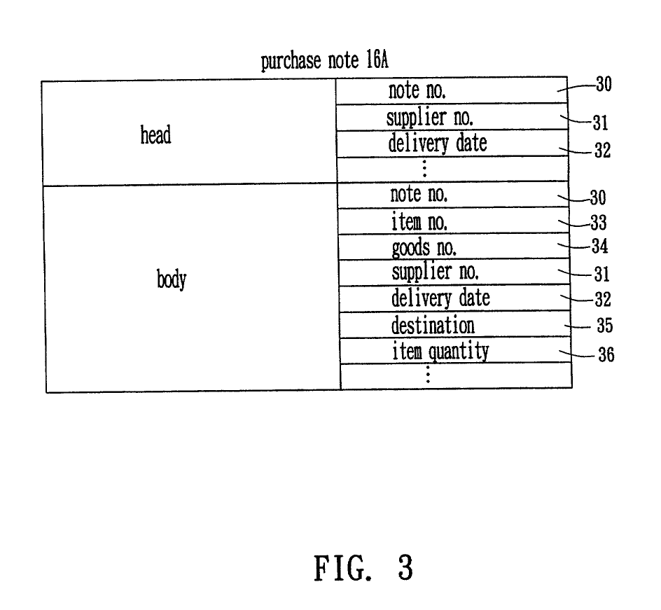

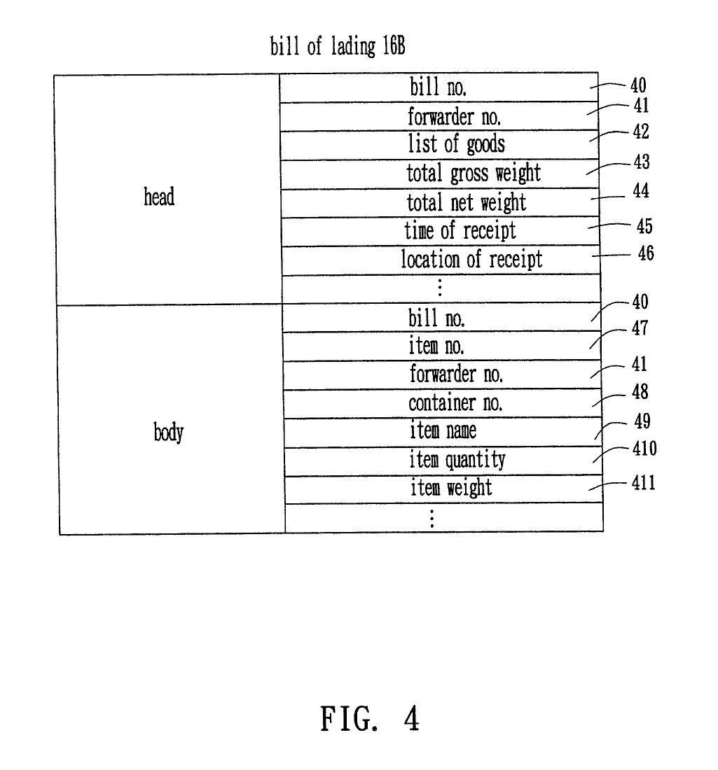

Referring to FIGS. 3 and 4, the purchase order information 16 comprises a purchase note 16A and a bill of lading 16B. The purchase note 16A relates to domestic purchasing, where the purchaser and supplier are both domestic corporations. The bill of lading 16B relates to overseas purchasing.

The purchase note 16A comprises a head and one or more bodies. The head of the purchase note 16A has basic information such as a note no. 30, a supplier no. 31, and a delivery date 32. The body of the purchase note 16A has more detailed information, such as an item no. 33, a goods no. 34, a destination 35, and an item quantity 36. A purchase note 16A has only one supplier and one delivery date 32.

The bill of lading 16B also comprises a head and one or more bodies. The head of the bill of lading 16B has basic information such as a bill no. 40, a forwarder no. 41, a list of goods 42, a total gross weight 43, a total net weight 44, a time of receipt 45, and a location of receipt 46. The body of the bill of lading 16B has more detailed information such as an item no. 47, a container no. 48, an item name 49, an item quantity 410, and an item weight 411. A bill of lading 16B has only one forwarder and one delivery date (not shown in FIG. 4).

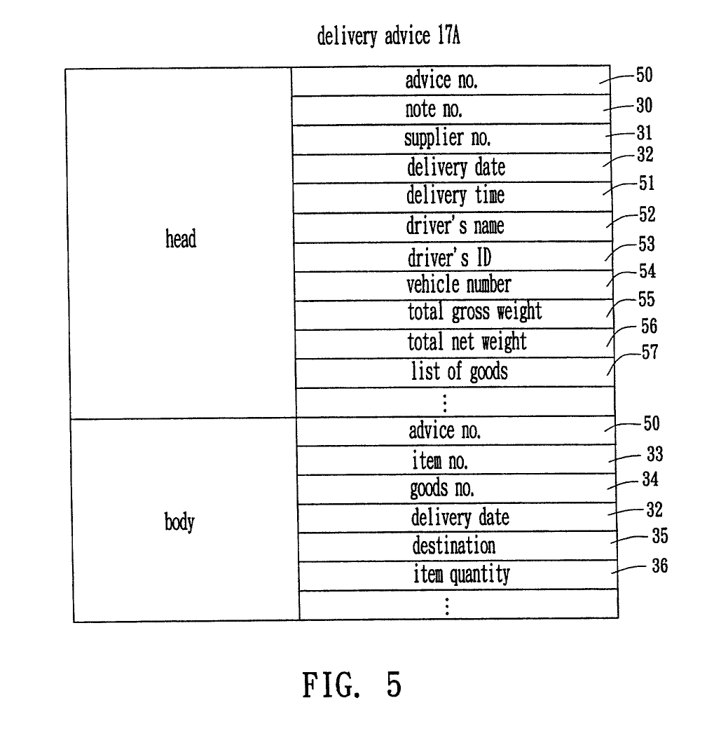

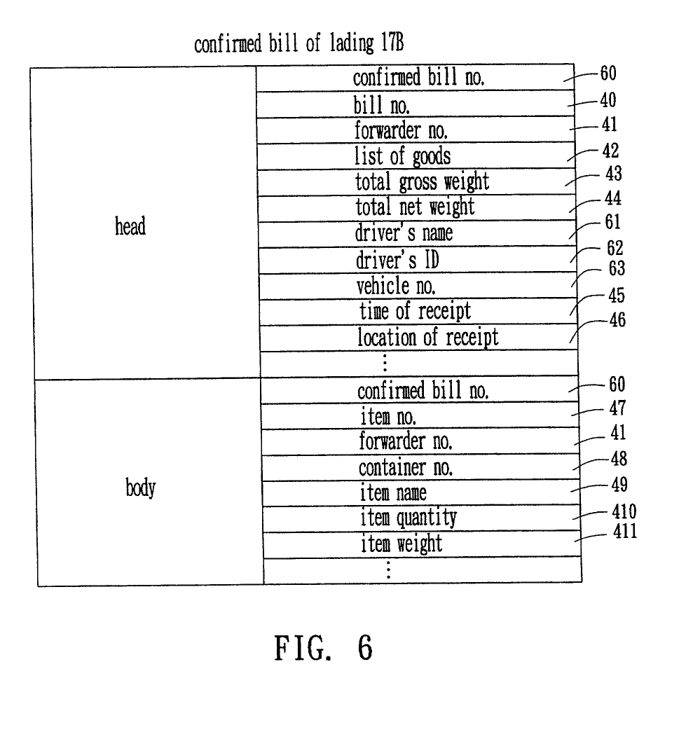

Referring to FIGS. 5 and 6, the delivery information 17 comprises a delivery advice 17A and a confirmed bill of lading 17B. The delivery advice 17A is created in response to the purchase note 16A, while the confirmed bill of lading 17B is created in response to the bill of lading 16B. The delivery information 17 must meet the specifications contained in the corresponding purchase order information 16. In fact a contents of the delivery information 17 is mainly derived from a contents of the corresponding purchase order information 16.

The delivery advice 17A comprises a head and one or more bodies. The head of the delivery advice 17A has basic information such as an advice no. 50, an arriving time 51, a driver's name 52, a driver's ID 53, a vehicle number 54, a total gross weight 55, a total net weight 56, and a list of goods 57. The body of the delivery advice 17A has more detailed information that is in fact derived from the corresponding purchase note 16A.

The confirmed bill of lading 17B comprises a head and one or more bodies. The head of the confirmed bill of lading 17B has basic information such as a confirmed bill no. 60, a driver's name 61, a driver's ID 62, and a vehicle number 63. The body of the confirmed bill of lading 17B has more detailed information that is in fact derived from the corresponding bill of lading 16B.

Referring to FIG. 7, a user 71 logs into and accesses the D/N system 10 via the electronic communications network 74. In the preferred embodiment, a communications web server database 72 is adapted to be accessible by the D/N system 10. All information related to the D/N system 10 is stored in the database 72.

In general a user 71 can access the D/N system 10 if he has a personal computer with a network browser such as Internet Explorer (IE) or Netscape, and if he is assigned with specific authority for accessing the D/N system 10. The operating system of the personal computer may be Windows 95, Windows 98, Windows 2000, Windows NT, or another suitable visual operation system. In the preferred embodiment, the browser is IE version 4.0, Netscape version 3.0, or other more advanced versions of IE or Netscape.

In the preferred embodiment, users 71 comprise system administrators and common users. Common users include a plurality of purchasers and a plurality of authorized suppliers 12. Different users 71 are assigned with different access authorities 73. Each access authority 73 provides a pre-determined scope of access to the corresponding user. System administrators hold universal access authorities 73, while common users have only specific limited access authorities 73. System administrators create common user information based on base information provided by common users in advance. System administrators also manage common users' login information. Each common user obtains permission to log into the system, and is assigned with a usemame and a password that cooperate to uniquely identify that common user in the D/N system 10. A common user has no authority to modify any personal information except his own password. Access authority of a purchaser includes creating purchase order information 16 and browsing delivery information 17. Access authority of a supplier 12 includes browsing purchase order information 16 and creating delivery information 17.

Referring to FIG. 8, the D/N system 10 comprises a base information module 81, a demand module 82, a supplier module 83 and a reporting module 84. The base information module 81 is mainly used for creating and maintaining base information 15, and for providing the base information 15 to other modules. First, common users provide their user information to the system administrators for login, and then the system administrators create and store user information in the D/N system 10. The base information module 81 may comprise a user management sub-module (not illustrated), for managing user information as described above. The user management sub-module assigns different authorities to different users as described above. The demand module 82 is mainly used for a purchaser to create purchase order information 16. The purchaser creates purchase order information 16 based on bills of material of all products and current stocks of each product. The supplier module 83 is mainly used for suppliers 12 to browse and confirm purchase order information 16 and to create delivery information 17. A supplier 12 creates delivery information 17 based on the corresponding purchase order information 16. The reporting module 84 allows users 71 to search information including purchase order information 16 and delivery information 17, and to print out searched information in tabular format.

FIG. 9 is a data flow chart showing various information transmitted among various parts of the D/N system 10. First, the demand module 82 receives information 90 from the production management system 18 which is outside the D/N system 10. The demand module 82 also receives information 91 from the base information module 81. The information 90 includes bills of material of all products and current inventory of each product. The information 91 includes the purchaser-to-supplier reference table 22. The demand module 82 generates information 92, based on the information 90, 91. The information 92 includes purchase order information 16. The supplier module 83 receives information 93 from the base information module 81, and also receives the information 92 from the demand module 82. The information 93 includes vehicle information 23 and driver information 24. The supplier module 83 generates information 94 including delivery information 17, based on the purchase order information 16. The reporting module 84 receives the information 94 from the supplier module 83, information 95 from the base information module 81, and the information 92 from the demand module 82. The information 95 includes user information, vehicle information 23, and driver information 24. The reporting module 84 generates various searching and reporting information in tabular form, based on information received from the above-mentioned modules.

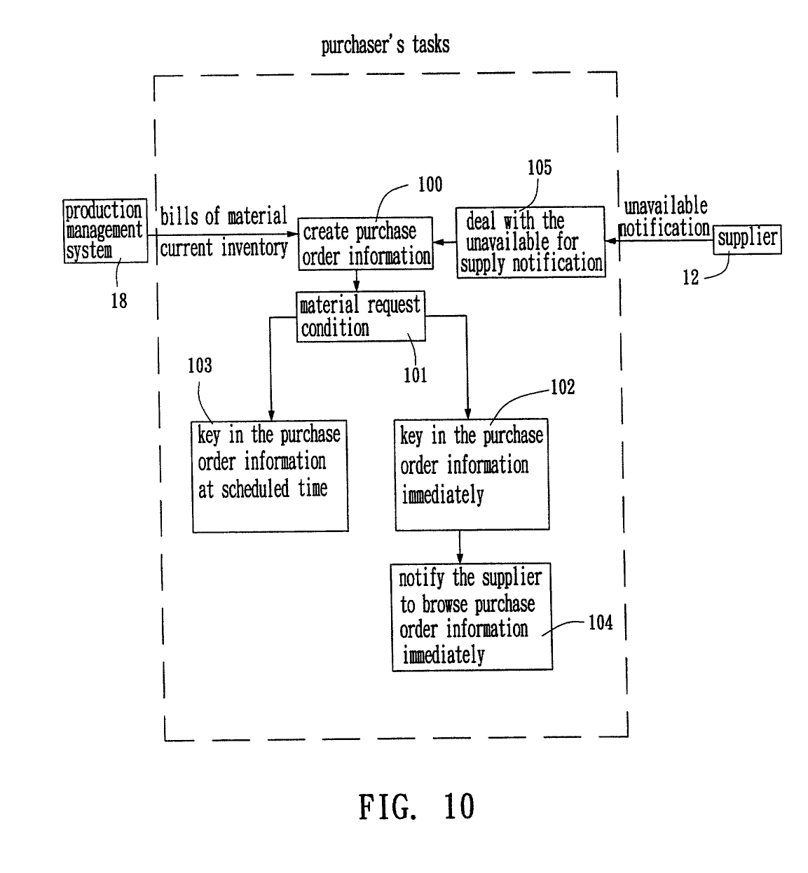

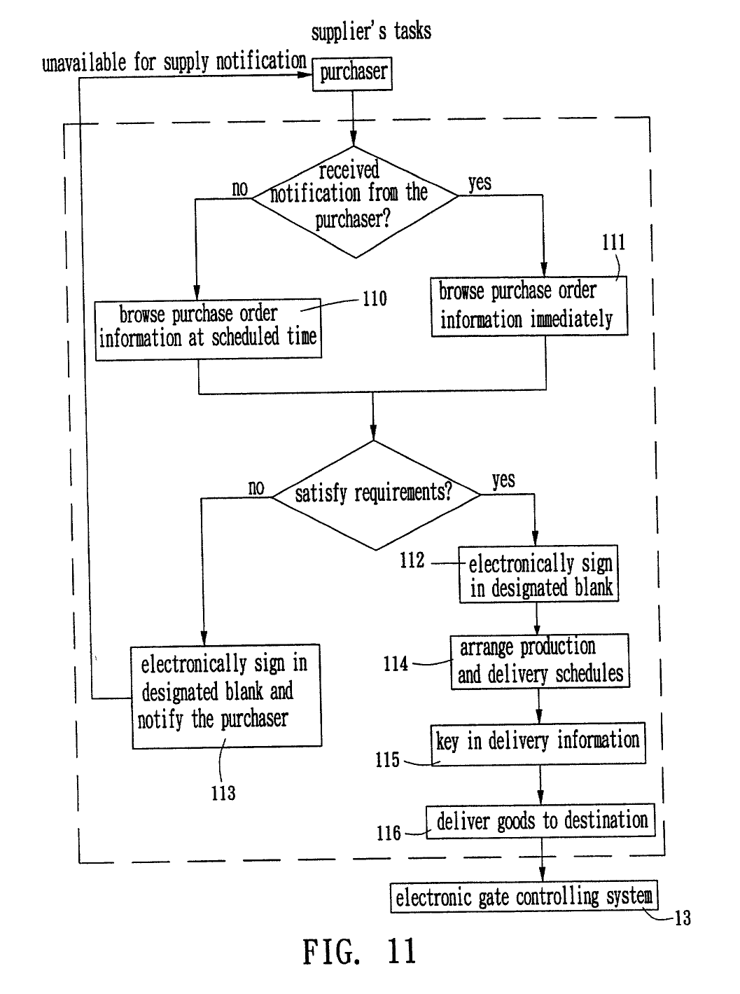

FIGS. 10 and 11 are flow charts of tasks performed by a purchaser and by a supplier respectively. First, referring particularly to FIG. 10, the purchaser creates purchase order information 16 based on bills of material of all products and current inventory of each product obtained from the production management system 18 (step 100). According to predetermined schedule, the purchaser creates purchase order information 16 every day. However, there would be some unexpected things such as the supplier 12 cannot satisfy the requirements. When such things occur, the purchaser will receive an “unavailable for supply” notification and deal with the “unavailable for supply” notification in time (step 105). Normally, the purchaser will make some changes on the purchaser order information 16 or create another new purchaser order information 16 (step 100). Followed the step 100, the purchaser decides whether the required material is needed urgently (step 101). If the required material is needed urgently, the purchaser keys in and stores the purchase order information 16 immediately (step 102), and notifies a supplier 12 that the supplier 12 should browse the purchase order information 16 immediately (step 104). The purchaser can notify the supplier 12 in a variety of ways, such as by telephone, fax or an electronic data network. If the required material is not needed urgently, the purchaser keys in and stores the purchase order information 16 at a scheduled time that has been predetermined by agreement between the purchaser and the supplier 12 (step 103).

Referring particularly to FIG. 11, if the supplier 12 receives notification from the purchaser that the supplier 12 should browse the purchase order information 16 immediately, the supplier 12 duly browses the purchase order information 16 immediately (step 111). Otherwise, the supplier 12 browses the purchase order information 16 at a scheduled time that has been predetermined by agreement between the purchaser and the supplier 12 (step 110). Following steps 110 or 111, the supplier decides whether he can satisfy requirements contained in the purchase order information 16, by comparing his current production status and current inventory with the purchase order information 16. If the supplier is able to satisfy the requirements, he electronically signs in a designated blank accompanying the purchase order information 16. Such signature constitutes an agreement that the supplier 12 will deliver the required material according to the purchaser's demands as contained in the purchase order information 16 (step 112). Otherwise, the supplier 12 electronically signs in another designated blank accompanying the purchase order 16 to advise the purchaser that the supplier 12 cannot meet the purchaser's demands, meanwhile the supplier has to notify the purchaser about the “unavailable for supply” notification in order that the purchaser has enough time to deal with the “unavailable for supply” notification (referring to step 105, step 113). The supplier 12 can notify the purchaser in many ways, such as via a telephone communication equipment or an electronic data network. Following step 112, the supplier 12 arranges production and delivery schedules according to the purchase order information 16 (step 114). The supplier 12 then keys in and stores the delivery information 17 into the D/N system 10 (step 115), and finally delivers the required goods to the required destination (step 116).

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A delivery notification system for users to transmit and exchange information over an electronic communications network, the delivery notification system comprising:
a base information module for creating, modifying and deleting base information needed by the delivery notification system;
a demand module for creating purchase order information on the network;
a supplier module for browsing the purchase order information, and creating delivery information on the network based on the purchase order information;
a reporting module for searching for the purchase order information and the delivery information;
wherein the base information module contains all the base information needed by the delivery notification system that is shared by the demand module, the supplier module and the reporting module; the demand module receives the base information from the base information module and produces the purchase order information shared by the demand module, the supplier module and the reporting module; and the supplier module receives the base information from the base information module and the purchase order information from the demand module and produces the delivery information shared by the demand module, the supplier module and the reporting module.

2. The delivery notification system as claimed in claim 1, further comprising a least one interactive user interface through which users access the delivery notification system.

3. The delivery notification system as claimed in claim 1, wherein the electronic communications network comprises items selected from the group consisting of the Internet and at least one intranet.

4. The delivery notification system as claimed in claim 1, wherein the base information module comprises a user management sub-module for managing user information.

5. The delivery notification system as claimed in claim 3, wherein the user management sub-module assigns different authorities to different users, each authority providing a pre-determined scope of access to the corresponding user.

6. The delivery notification system as claimed in claim 1, wherein the base information module allows a system administrator to set up and maintain user information provided by users in advance.

7. The delivery notification system as claimed in claim 1, wherein the base information module provides a purchaser-to-supplier reference table that provides selectable supplier information.

8. The delivery notification system as claimed in claim 1, wherein the purchase order information includes a purchase note for domestic trade.

9. The delivery notification system as claimed in claim 1, wherein the purchase order information includes a bill of lading for overseas trade.

10. The delivery notification system as claimed in claim 1, wherein the delivery information includes a delivery advice in response to the purchase note.

11. The delivery notification system as claimed in claim 1, wherein the delivery information includes a confirmed bill of lading in response to the bill of lading.

12. A method for delivery notification through a delivery notification system in which users transmit and exchange information over an electronic communications network, the method for delivery notification comprising the steps of:
(a) providing base information on each of a plurality of users to a system administrator, for obtaining permission for each user to log into the system;
(b) creating a user information table based on the users' base information;
(c) logging into the delivery notification system;
(d) creating and storing purchase order information in the system;
(e) browsing and confirming the purchase order information, and arranging production and delivery schedules based on the purchase order information;
(f) creating and storing delivery information in the system;
(g) delivering goods to a destination; and
(h) checking the goods based on the delivery information.

13. The method for delivery notification as claimed in claim 12, wherein the electronic communications network comprises items selected from the group consisting of the Internet and at least one intranet.

14. The method for delivery notification as claimed in claim 12, wherein step
(a) further comprises the step of assigning different authorities to different users to enable the users to access the system.

15. The method for delivery notification as claimed in claim 12, wherein step
(b) is performed only by at least one system administrator, for security.

16. The method for delivery notification as claimed in claim 12, wherein step
(b) further comprises the step of managing the user login information.

17. The method for delivery notification as claimed in claim 14, wherein step
(c) further comprises the step of providing at least one interactive user interface through which users log into the delivery notification system by using their respective authorities.

18. The method for delivery notification as claimed in claim 12, wherein the purchase order information created is based on bills of material and current inventory of the purchaser.

19. The method for delivery notification as claimed in claim 12, wherein step
(d) further comprises the step of creating a purchase note for domestic trade.

20. The method for delivery notification as claimed in claim 12, wherein step
(d) further comprises the step of creating a bill of lading for overseas trade.

21. The method for delivery notification as claimed in claim 12, wherein step
(e) further comprises an alternative step of notifying the purchaser in real time when a supplier cannot meet the purchaser's demands according to the purchase order information.

22. The method for delivery notification as claimed in claim 12, wherein step
(f) of creating delivery information is performed based on the purchase order information.

23. The method for delivery notification as claimed in claim 19, wherein step
(f) further comprises the step of creating a delivery advice in response to the purchase note.

24. The method for delivery notification as claimed in claim 20, wherein step
(f) further comprises the step of creating a confirmed bill of lading in response to the bill of lading.

25. A delivery operation system assembly comprising:
a delivery notification system storing base information thereof;
a production management system providing bills of material and current inventory to a purchase center, said purchase center providing purchase order information to and obtaining the base information from the delivery notification system;
said delivery notification system sending the purchase order information to a supplier and said supplier sending delivery information back to the delivery notification system;
said delivery notification system sending the delivery information to an inspection station controlling system;
said delivery notification system sending the delivery information and driver information to an electronic gate controlling system; and
said delivery system sending customs declaration information to electronic customs system.
